(19) United States
(12) Patent Application Publication
(10) Pub. No.: US 2025/0115107 A1
(43) Pub. Date: Apr. 10, 2025

(54) DRIVE DEVICE

(71) Applicant: TOYOTA JIDOSHA KABUSHIKI KAISHA, Toyota-shi (JP)

(72) Inventor: Eiji ICHIOKA, Toyota-shi (JP)

(73) Assignee: TOYOTA JIDOSHA KABUSHIKI KAISHA, Toyota-shi (JP)

(21) Appl. No.: 18/766,894

(22) Filed: Jul. 9, 2024

(30) Foreign Application Priority Data
Oct. 5, 2023 (JP) 2023-173791

(51) Int. Cl. B60K 1/02; B60K 17/14; F16H 57/04

(52) U.S. Cl. CPC B60K 1/02; B60K 17/145; F16H 57/0482

(57) ABSTRACT

A first drive unit including a first motor and a first gear for driving a left wheel of the vehicle, a second drive unit including a second motor and a second gear for driving a right wheel of the vehicle, a housing for accommodating the first drive unit and the second drive unit, and capable of storing the lubricant to such an extent that a part of the first gear and the second gear is immersed, and a lubricant merging portion for merging the lubricant scraped up by the first gear and the lubricant scraped up by the second gear.

### CROSS-REFERENCE TO RELATED APPLICATION

This application claims priority to Japanese Patent Application No. 2023-173791 filed on Oct. 5, 2023, incorporated herein by reference in its entirety.

### BACKGROUND

### 1. Technical Field

The technology disclosed herein relates to a drive device.

### 2. Description of Related Art

Japanese Unexamined Patent Application Publication No. 2016-205444 (JP 2016-205444 A) discloses an electrified vehicle including a drive unit that includes gear sets and motors that independently correspond to right and left wheels, respectively.

### SUMMARY

In a vehicle such as an electrified vehicle, a housing capable of storing a lubricant to be supplied to a gear set and a motor is provided for each of right and left wheels. A lower portion of a gear as a part of the gear set is partially immersed in the lubricant stored in a bottom portion of the housing. The gear splashes the lubricant upward as the gear rotates. A storage portion for the lubricant provided above each gear receives and stores the splashed lubricant and discharges the lubricant into the housing. As a result, the gear set and the motor are lubricated and cooled by the lubricant.

When the vehicle turns to the right, for example, the lubricant tends to move to the left side in the housing because of the turning gravity. Therefore, the amount of the lubricant decreases in the vicinity of the gear for the right wheel, and the amount of splashed oil also decreases. This may make it difficult to ensure a sufficient amount of the lubricant to be supplied to the motor for the right wheel.

The present specification provides a technique capable of stably supplying a lubricant to drive units for right and left wheels when a vehicle such as an electrified vehicle is traveling.

An aspect of the technology disclosed herein is embodied as a drive device. The drive device includes: a first drive unit that includes a first motor and a first gear that drive a left wheel of a vehicle;

a second drive unit that includes a second motor and a second gear that drive a right wheel of the vehicle; and
a housing that accommodates the first drive unit and the second drive unit and that is able to store a lubricant to an extent that a portion of the first gear and the second gear is immersed. The drive device further includes a lubricant merging portion that merges the lubricant splashed up by the first gear and the lubricant splashed up by the second gear.

In this drive device, the lubricant splashed up by the first gear and the lubricant splashed up the second gear are merged and aggregated at the lubricant merging portion. Due to the action of the high turning gravity generated during turning of the vehicle during traveling, there may be a deviation between the right and the left sides in the distribution of the lubricant in the housing, and there may be a deviation in the amount of the splashed lubricant between the right and the left sides of the vehicle. Even in such a case, the lubricant merging portion collectively aggregates the lubricants splashed up on the right and left sides, and therefore a stable amount of the lubricant is merged and aggregated at the lubricant merging portion without being affected by the fluctuations in the amount of the lubricant between the right and the left sides.

By providing such a lubricant merging portion, the lubricant can be stably supplied to the first drive unit and the second drive unit even during traveling in which a high turning gravity is input.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing an embodiment of a drive device provided in a wheel of a vehicle;

FIG. 2 is a view from the vehicle left of the drive device of the front wheels;

FIG. 3 is a plan view illustrating a configuration of a motor and a gear set in the drive device;

FIG. 4A is a plan view of the lubricant merging portion;

FIG. 4B is an arrow B view of FIG. 4A;

FIG. 4C is an arrow C view of FIG. 4A;

FIG. 5A is a plan view showing a lubricant circulation mode by a lubricant merging portion when a vehicle is turned rightward;

FIG. 5B is a view of the lubricant merging portion from the left side of the car;

FIG. 6A is a plan view showing another embodiment of a drive device, and also shows a circulation form of a lubricant when a vehicle is turned rightward;

FIG. 6B is a view of the lubricant merging portion from the left side of the car;

FIG. 7A is a plan view of the lubricant merging portion;

FIG. 7B is an arrow B view of FIG. 7A; and

FIG. 7C is a C arrow view of FIG. 7A.

### DETAILED DESCRIPTION OF EMBODIMENTS

One aspect of the drive device disclosed herein may comprise, as previously described, the following configuration: a first drive unit comprising a first motor and a first gear for driving left wheels of the vehicle; a second drive unit comprising a second motor and a second gear for driving right wheels of the vehicle; a housing accommodating the first drive and the second drive and capable of storing the lubricant to such an extent that a portion of the first gear and the second gear is immersed; and a lubricant merging portion joining the lubricant scraped up by and first gear and the lubricant scraped up by the second gear. In the present specification, the lubricant is not particularly limited, but is, for example, an oil-like material.

Another aspect of the drive device may include the lubricant merging portion including the following configuration: a storage portion capable of storing the lubricant; a first intake port for taking in the lubricant scraped up by the first gear in the storage portion; a second intake port for taking in the lubricant scraped up by the second gear in the storage portion; and one or more discharge ports for discharging the lubricant from and storage portion toward the first drive unit and the second drive unit. According to such a lubricant merging portion, since the lubricant is stored in the storage portion, it is possible to effectively suppress the variation in the amount of the lubricant, and it is possible to supply the lubricant to the first drive unit and the second drive unit more stably.

In this aspect, the one or more discharge ports may include a first discharge port for discharging the lubricant toward the first motor and a second discharge port for discharging the lubricant toward the second motor. In this way, the first drive unit and the second drive unit can be stably and reliably lubricated and cooled, respectively.

In another aspect of the drive device, the lubricant merging portion may include a flow path member including a first flow path, a second flow path, a connection portion between the first flow path and the second flow path, and a third flow path. The first flow path may have a first intake port for taking in the lubricant scraped up by the first gear. The second flow path may have a second intake port for taking in the lubricant scraped up by the second gear. The third flow path may include one or more discharge ports extending from the connection portion and discharging the lubricant toward the first drive unit and the second drive unit. In this way, the lubricant from the first intake port and the second intake port is merged and aggregated in the connecting portion and the third flow path. Therefore, the amount of lubricant supplied to the first drive unit and the second drive unit can be effectively stabilized.

In this aspect, the lubricant merging portion may further include a storage portion that communicates with the first flow path and the second flow path and can store the lubricant. In this way, for example, excessive lubricant can be stored in the storage portion in the first flow path and the second flow path to stabilize the discharge amount and optimize the stirring loss in the flow path.

In this aspect, the one or more ejection ports may include one ejection port for ejecting the lubricant toward the first drive unit and the second drive unit. With one discharge port, the lubricant can be stably supplied to the first drive unit and the second drive unit while simplifying the structure.

### First Embodiment

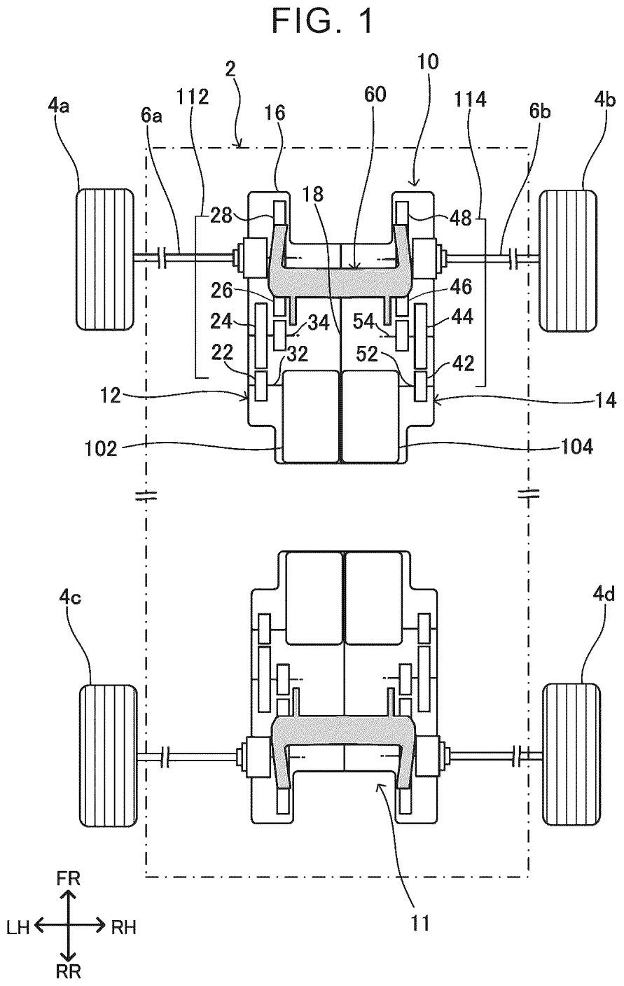

Hereinafter, a drive device 10 according to an embodiment of the present disclosure will be described with reference to the drawings. FIG. 1 to FIG. 5B show a drive device 10 provided in a wheel 4a, 4b in front of a vehicle 2, which is mainly an electrified vehicle of four-wheel driving. Since the rear wheels of the vehicle 2 are 4c, 4d and symmetrical in the front-rear direction, the explanation thereof will be omitted. Note that the vehicle 2 may not be a four-wheel drive vehicle, and may be a front-wheel drive or a rear-wheel drive two-wheel drive vehicle other than a four-wheel drive vehicle. Vehicle 2 also broadly refers to an electrified vehicle having a motor for driving at least one wheel. For example, the vehicle 2 include a battery electrified vehicle, a hybrid electrified vehicle, a plug-in hybrid electrified vehicle, and a fuel-cell electrified vehicle.

Here, the direction FR in the drawing indicates the front in the front-rear direction of the vehicle 2, and the direction RR indicates the rear in the front-rear direction of the vehicle 2. The direction LH indicates the left in the left-right direction of the vehicle 2, and the direction RH indicates the right in the left-right direction of the vehicle 2. Further, the direction UP indicates an upward direction in the up-down direction of the vehicle 2, and the direction DW indicates a downward direction in the up-down direction of the vehicle 2. Normally, the front-rear direction and the left-right direction of the vehicle 2 are horizontal directions, and the up-down direction of the vehicle 2 is a vertical direction.

As illustrated in FIG. 1, the drive device 10 drives a wheel 4a in front of the vehicle 2 and a wheel 4b in front thereof. The drive device 10 includes a drive unit 12 for wheel 4a, a drive unit 14 for wheel 4b, and a lubricant merging portion (hereinafter, also simply referred to as a merging portion) 60 for supplying lubricant LB thereto. The drive units 12 and 14 and the merging portion 60 are housed in the housing 16. As will be described later, the housing 16 can store a lubricant (liquid) for lubricating and cooling the elements of the drive units 12 and 14. The housing 16 is made of, but not limited to, a metal material. In the example shown in FIG. 1, only the lower portions of the drive units 12 and 14 are separated by the partition wall portion 18 provided at the bottom of the housing 16.

As illustrated in FIG. 1, the drive unit 12 includes an electric motor 102, a gear set 112 connected to the wheel 4a and the electric motor 102, and an inverter (not illustrated) that controls the electric motor 102. The gear set 112 is connected to the wheel 4a via a drive shaft 6a. The power of the electric motor 102 is transmitted to the wheel 4a via the gear set 112. The drive unit 12 is an example of the first drive unit disclosed in this specification, and the electric motor 102 is an example of the first motor.

The electric motor 102 includes a rotor and a core (not shown), and the drive shaft 32 rotates as the rotor rotates. The rotor and the core of the electric motor 102 are exposed to a space in the housing 16.

Like the drive unit 12, the drive unit 14 includes an electric motor 104, a gear set 114 connected to the wheel 4b and the electric motor 104, and an inverter (not shown) that controls the electric motor 104. The gear set 114 is connected to the wheel 4b via a drive shaft 6b. The power of the electric motor 104 is transmitted to the wheel 4b via the gear set 114. The drive unit 14 is an example of the second drive unit disclosed in this specification, and the electric motor 104 is an example of the second motor.

The electric motor 104 includes a rotor and a core (not shown), and the drive shaft 52 rotates as the rotor rotates. The electric motor 104 is partitioned by a partition wall portion 18 having a predetermined height and disposed in the housing 16, and the rotor and the core thereof are exposed in the housing 16.

As shown in FIG. 1, the gear set 112 for the wheel 4a and the gear set 114 for the wheel 4b are symmetrical to each other. The gear sets 112 and 114 are disposed on the left and right sides of the partition wall portion 18, and are exposed in the housing 16. The partition wall portion 18 also isolates the lubricant LB.

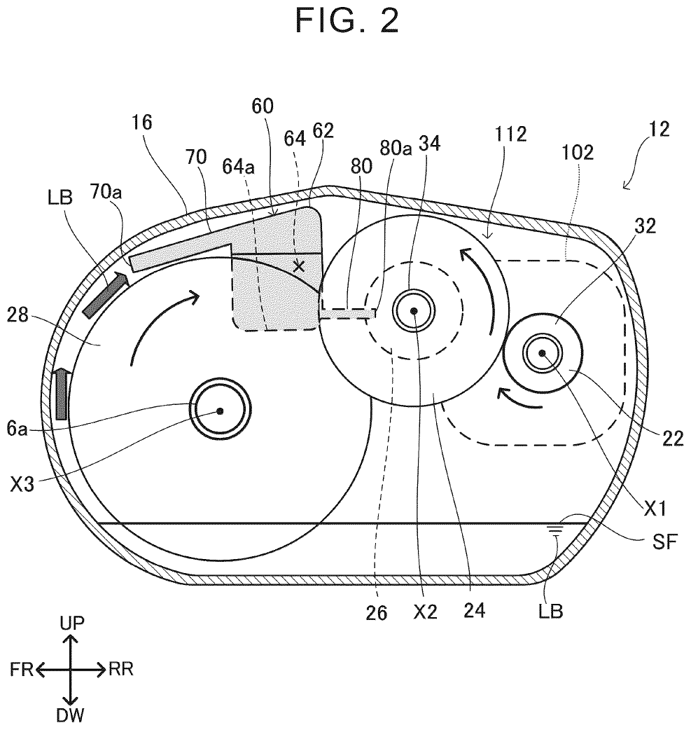

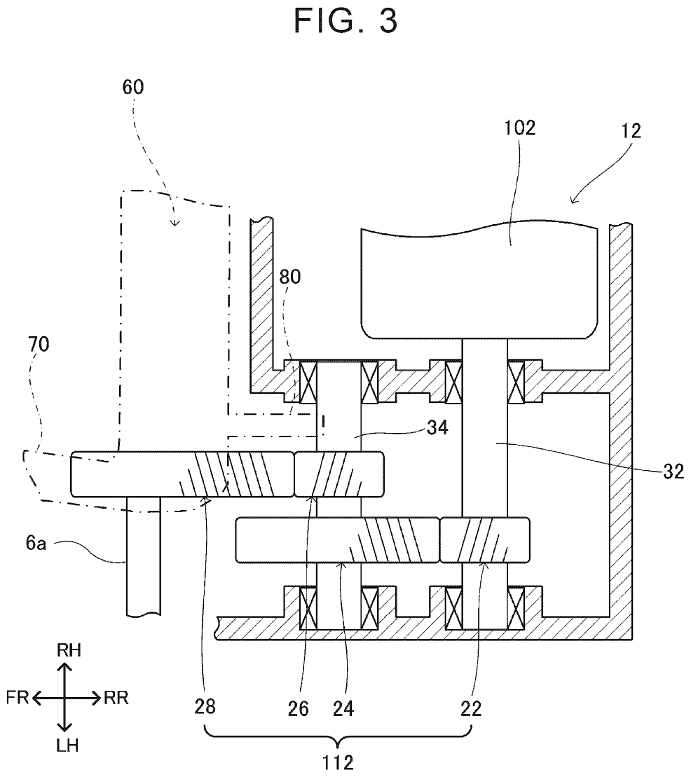

As shown in FIGS. 2 and 3, gear sets 112 and 114 include a plurality of gears 22 to 28 and 42 to 48, respectively. The gear set 112 includes a drive gear 22, a first counter gear 24, a second counter gear 26, and a ring gear 28. The gear set 114 includes a drive gear 42, a first counter gear 44, a second counter gear 46, and a ring gear 48.

The drive gears 22 and 42 are external gear gears, and are provided on the drive shafts 32 and 52. The drive shafts 32 and 52 are disposed along the first rotational shaft X1 extending in the left-right direction. The drive shafts 32, 52 are mounted to the housing 16 via a plurality of bearings and are rotatably supported. The drive shafts 32 and 52 are connected to the electric motors 102 and 104, and are rotationally driven by the electric motors 102 and 104. The drive gears 22, 42 are non-rotatably fixed to the drive shafts 32, 52 and rotate together with the drive shafts 32, 52.

The first counter gears 24 and 44 and the second counter gears 26 and 46 are external gear. The first counter gears 24, 44 and the second counter gears 26, 46 are provided on the counter shafts 34, 54. The counter shafts 34 and 54 are disposed along the second rotation shaft X2 extending in the left-right direction. The counter shafts 34, 54 are mounted to the housing 16 via a plurality of bearings and are rotatably supported. The first counter gears 24, 44 and the second counter gears 26, 46 are non-rotatably fixed to the counter shafts 34, 54 and rotate together with the counter shafts 34, 54. The first counter gears 24, 44 mesh with the drive gears 22, 42. Accordingly, when the drive gears 22 and 42 are rotationally driven by the electric motors 102 and 104, the first counter gear 24 and the second counter gear 26 rotate in a direction opposite to the rotation direction of the drive gear 22. The outer diameters of the first counter gears 24, 44 are larger than the outer diameters of the drive gears 22, 42. Therefore, a first deceleration (in other words, torque amplification) is performed between the drive shafts 32, 52 and the counter shafts 34, 54. The outer diameters of the second counter gears 26 and 46 are smaller than the outer diameters of the first counter gears 24 and 44.

The ring gears 28, 48 are external gear. As described above, the ring gears 28 and 48 are disposed along the third rotational shaft X3 extending in the left-right direction. The ring gears 28, 48 are non-rotatably fixed to a drive shaft 6a, 6b attached to the housing 16 via a plurality of bearings (not shown). The ring gears 28, 48 mesh with the second counter gears 26, 46. Accordingly, as the second counter gears 26, 46 rotate, the ring gears 28, 48 rotate in a direction opposite to the direction of rotation of the second counter gears 26, 46 (in the embodiment shown in FIGS. 2 and 3, they rotate behind the vehicle 2). A wheel 4a and a wheel 4b are connected to the drive shaft 6a, 6b. The ring gears 28, 48 are examples of the first and second gears disclosed herein.

As shown in FIG. 2, a lubricant LB is accommodated in the housing 16. The lubricant LB lubricates and cools the components of the drive units 12, 14, such as gear sets 112, 114 and motors 102, 104. The lubricant LB is stored in the lower portion of the housing 16, and a portion of the ring gears 28 and 48 are usually immersed in the lubricant LB. That is, a portion of the ring gears 28, 48 is located below the oil-level SF of the lubricant LB. On the other hand, the drive gears 22 and 42, the first counter gears 24 and 44, and the second counter gears 26 and 46 are positioned above the oil level SF of the lubricant LB. As shown by the plurality of blocking arrows in FIG. 2, as the ring gears 28, 48 rotate, the lubricant LB is scraped up by the ring gears 28, 48. lubricant merging portion

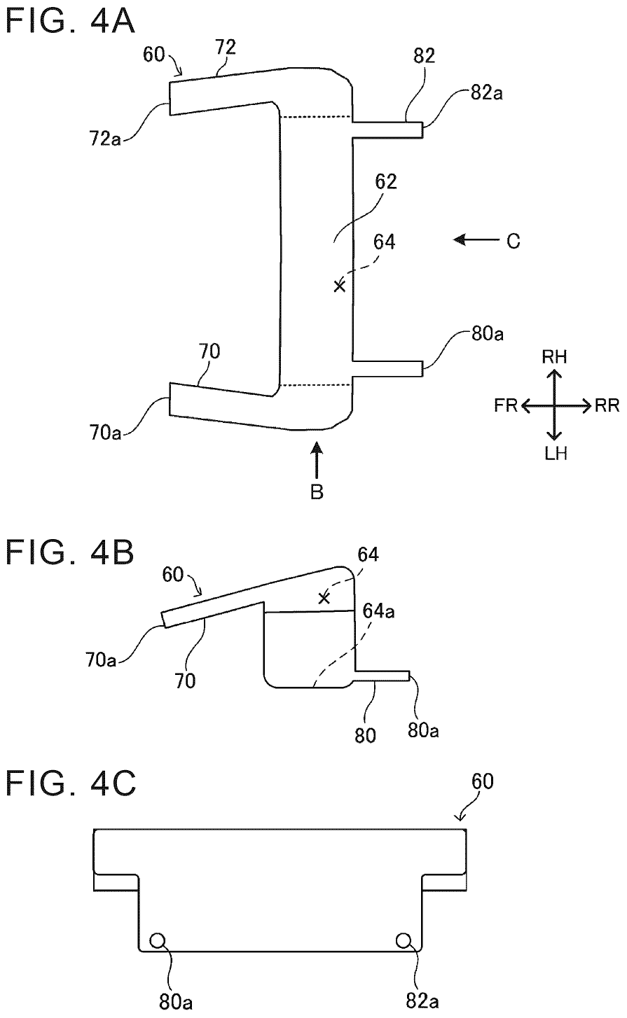

As shown in FIGS. 1 and 2, one merging portion 60 is provided in common to the drive units 12 and 14. As shown in FIG. 2 and FIG. 4A, FIG. 4B, and FIG. 4C, the merging portion 60 includes a storage portion 62 of the lubricant LB, intake portions 70 and 72 of the lubricant LB, and discharge portions 80 and 82 of the lubricant LB. The merging portion 60 is generally disposed between the left and right ring gears 28, 48. The merging portion 60 is an outer shell body having an inner space that is in communication with the intake portions 70 and 72 and the discharge portions 80 and 82 only in the outside.

As shown in the FIGS. 4A, 4B, and 4C, the storage portion 62 comprises a storage tank 64 having a lower bottom 64a than the circumference, which is housed between the ring gears 28, 28. In this way, the lubricant LB taken from the left and right intake portions 70 and 72 can be merged and aggregated into the storage tank 64. The storage portion 62 is configured to be filled with the lubricant LB to the maximum extent of the volume of the storage tank 64 during the operation of the drive device 10.

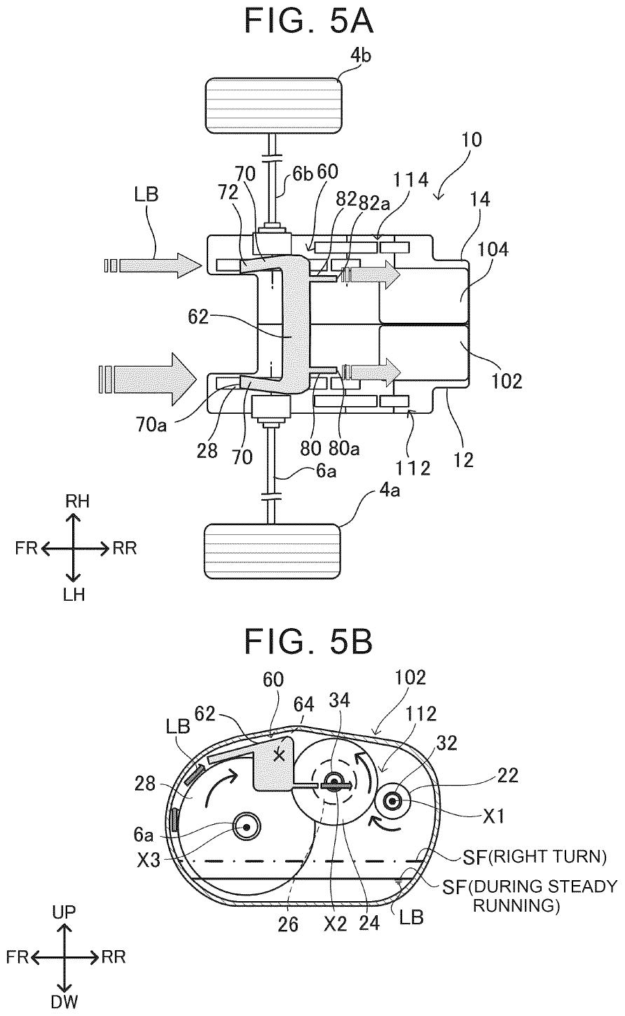

The intake portions 70 and 72 are pipelines extending from the left and right end portions of the upper portion of the storage portion 62 or the vicinity thereof. As shown in FIG. 2, FIG. 4A, FIG. 4B, FIG. 4C, FIG. 5A, and FIG. 5B, the intake portions 70 and 72 extend along a part of the upper peripheral edge of the ring gears 28 and 48, respectively, and extend forward and obliquely downward of the vehicle 2. Each of the intake portions 70 and 72 is provided with an intake port 70a, 72a for taking in the lubricant LB at a distal end portion thereof.

The discharge portions 80 and 82 are pipelines extending from a part close to the left and right bottom 64a of the storage tank 64 toward the rear of the vehicle 2. In FIG. 2, the discharge portions 80 and 82 extend in a generally horizontal direction. Each of the discharge portions 80 and 82 includes a discharge port 80a, 82a for discharging the lubricant LB at a distal end portion thereof. The discharge port 80a, 82a is capable of supplying lubricant LB to, for example, the drive gears 22 and 42, the first counter gears 24 and 44, the second counter gears 26 and 46, the motors 102 and 104, and other components of the drive units 12 and 14, respectively.

Next, the operation of the drive device 10 will be described referring to FIG. 2, FIG. 4A, FIG. 4B, FIG. 4C, FIG. 5A, and FIG. 5B. Note that, in FIG. 5B, the merging portion 60 is described at the foremost position and emphasized. When the motors 102, 104 of the drive device 10 are actuated and the drive gears 22, 42 are rotated, the first counter gears 24, 44, the second counter gears 26, 46 and the ring gears 28, 48 are rotated accordingly, respectively. By rotating the ring gears 28 and 48, the lubricant LB is taken into the storage portion 62 from the intake port 70a, 72a of the merging portion 60 along the pipelines of the intake portions 70 and 72, respectively. The rotational directions of the ring gears 28 and 48 do not necessarily have to coincide with the rotational directions of the wheel 4a, 4b. In the drive device 10 according to the present embodiment, the rotational directions of the ring gears 28 and 48 are reversed by gears (not shown) and transmitted to the wheel 4a, 4b.

The lubricant LB taken into the storage portion 62 merges into the storage tank 64 and is aggregated. Here, since there is no deviation between the left and right of the lubricant LB in the housing 16 during steady running, the amount of lubricant LB taken in from the intake portions 70 and 72 does not significantly differ between the left and right, and a sufficient amount of lubricant LB is taken in the merging portion 60. The lubricant LB merged into the storage tank 64 via the left and right intake portions 70 and 72 passes through the pipelines of the left and right discharge portions 80 and 82, and is discharged from the discharge port 80a, 82a into the housing 16.

On the other hand, a deviation of the lubricant LB may occur in the housing 16 due to the turning gravitational force. For example, during a right turn, in the right drive unit 14, the lubricant LB is biased toward the center of the vehicle 2, such as toward the motor 104, rather than toward the ring gear 48. Therefore, the lubricant LB around the ring gear 48 is reduced, the oil level is lowered, and the amount of scraping by the ring gear 48 is reduced. On the other hand, as shown in FIG. 5B, in the left drive unit 12, the lubricant LB is biased from the center side of the vehicle 2 toward the ring gear 28 side. Therefore, the lubricant LB around the ring gear 28 is increased, the oil level is increased, and the amount of scraping by the ring gear 28 is increased.

According to the drive device 10, even if the amounts of the lubricant LB taken in from the left and right intake portions 70 and 72 fluctuate due to the deviation of the lubricant LB, the lubricant LB joins at the merging portion 60 and is collectively collected in the storage tank 64. Therefore, variation in the storage quantity of the lubricant LB in the storage tank 64 is suppressed. As a result, the discharge pressure of the lubricant LB from the storage tank 64 is stably secured. In addition, as shown in FIG. 5A, it is possible to suppress or avoid an imbalance in the discharge amount from the left and right discharge port 80a, 82a, and a stable discharge amount of the lubricant LB is secured. In addition, since a substantially full amount of lubricant LB is stored in the storage tank 64, variation in the amount of lubricant LB is suppressed more effectively, and the discharge pressure is also stabilized.

### Second Embodiment

Next, a drive device 110 according to another embodiment of the drive device disclosed in this specification will be described. The drive device 110 has the same configuration as that of the drive device 10 except for the merging portion 160. In the following description, elements of the drive device 110 that are common to the drive device 10 are denoted by the same element numbers, and description thereof will be omitted.

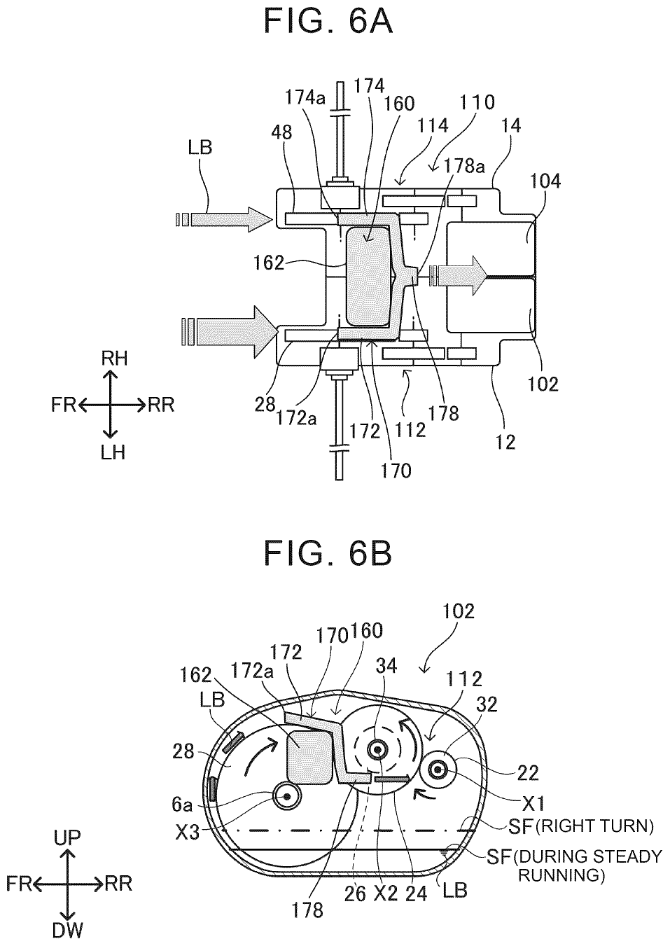

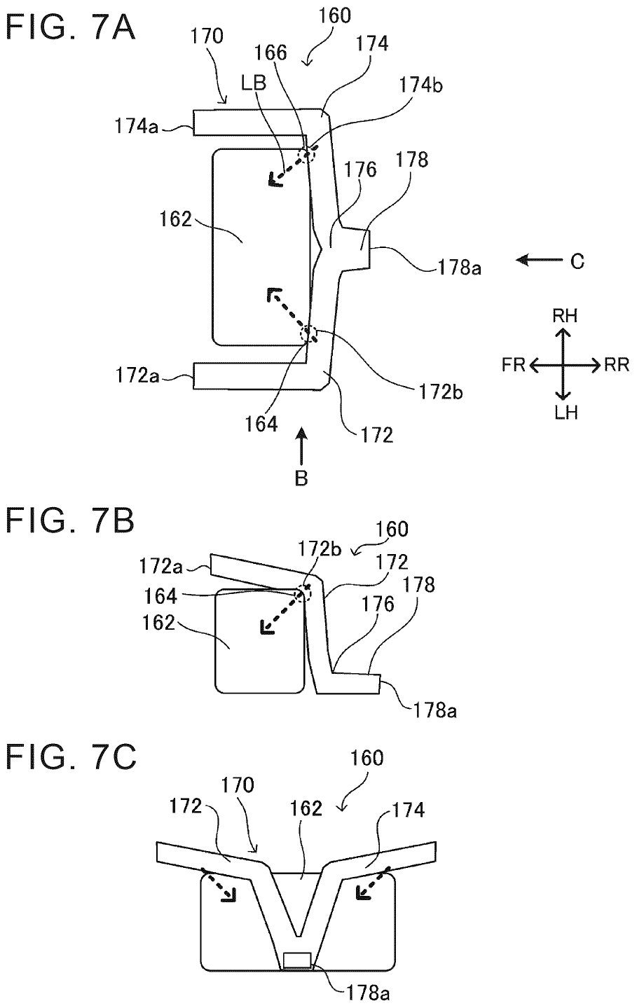

The merging portion 160, as shown in FIG. 6A, FIG. 6B, FIG. 7A, FIG. 7B, and FIG. 7C, are provided one commonly to the drive units 12, 14. The merging portion 160 is generally provided between the left and right gear sets 112, 114 and in the vicinity of the ring gears 28, 48. The merging portion 160 includes a storage portion 162 of the lubricant LB and a flow path member 170 that takes in and discharges the lubricant LB.

The storage portion 162 has an inner space capable of storing the lubricant LB. The storage portion 162 is disposed between the left and right ring gears 28, 48. The storage portion 162 includes introduction hole portions 164 and 166 so that the lubricant LB can be taken into the storage portion 162. The introduction hole portions 164 and 166 are provided at the left and right end portions of the upper end portion of the storage portion 162, which is closer to the rear side of the vehicle 2, or at a portion close thereto. As a result, the lubricant LB is introduced into the storage portion 162 via the flow path member 170.

The flow path member 170 includes a first flow path 172, a second flow path 174, a connecting portion 176, and a third flow path 178. The flow path member 170 has a bifurcated shape as a whole. The first flow path 172 and the second flow path 174 extend from the upper edge or the vicinity of the upper edge or the vicinity of the ring gears 28 and 48 on the left and right sides of the vehicle 2 toward a height position between the central portion of the vehicle 2 and the lower edge or the vicinity of the lower edge or the vicinity of the second counter gears 26 and 46 to the lower edge or the vicinity of the first counter gears 24 and 44, respectively. The first flow path 172 and the second flow path 174 extend obliquely downward toward the rear of the vehicle 2. The first flow path 172 and the second flow path 174 merge at or near the center of the vehicle 2 to form a connecting portion 176.

Each of the first flow path 172 and the second flow path 174 includes an intake port 172a, 174a of a lubricant LB. The intake port 172a, 174a open in front of the vehicle 2, respectively, and can take in the lubricant LB scraped up by the gears 28, 48. The first flow path 172 and the second flow path 174 each include discharge hole portions 172b, 174b of the lubricant LB in the middle of the flow path. The discharge hole portions 172b, 174b are provided at portions corresponding to the introduction hole portions 164 and 166 of the storage portion 162, respectively. In the first flow path 172 and the second flow path 174, the discharge hole portions 172b, 174b communicate with the inside of the storage portion 162 via the introduction hole portions 164 and 166.

The third flow path 178 further extends from the connecting portion 176 to the rear of the vehicle 2. The third flow path 178 includes one discharge port 178a that opens to the rear of the vehicle 2. The third flow path 178 extends substantially horizontally from the connecting portion 176 to the rear of the vehicle 2, and the discharge port 178a opens toward the center of the left and right motors 102 and 104. As a result, the lubricant LB is mainly supplied toward the motors 102 and 104.

The operation in such a drive device 110 will now be described with reference to FIG. 6A, FIG. 6B, FIG. 7A, FIG. 7B and FIG. 7C. Note that, in FIG. 6B, the merging portion 60 is described at the foremost position and emphasized. When the motors 102, 104 of the drive device 110 are actuated, the drive gears 22, 42 are rotated and the ring gears 28, 48 are rotated accordingly to scrape the lubricant LB.

The scraped-up lubricant LB is taken in from the intake port 172a, 174a of the merging portion 160 and passes through the first flow path 172 and the second flow path 174, respectively. Then, the lubricant LB reaches the connecting portion 176, is merged, and is discharged from the discharge port 178a via the third flow path 178. Further, as shown in FIG. 7A, FIG. 7B, and FIG. 7C, the lubricant LB excessively taken into the first flow path 172 and the second flow path 174 is appropriately introduced into the storage portion 162 via the discharge hole portions 172b, 174b and the introduction hole portions 164 and 166, and is stored therein. As a result, the stirring coefficient in the first flow path 172, the second flow path 174, and the like is optimized.

Here, since there is no deviation of the lubricant LB from the left and right in the housing 16 during steady running, the lubricant LB from the first flow path 172 and the second flow path 174 does not differ greatly from each other, and a constant quantity is stably discharged from the discharge port 178a.

On the other hand, as described above, a deviation of the lubricant LB occurs in the housing 16 due to the swiveling gravitational force, such as during a right-swivel, and the amount of the lubricant LB taken in from the first flow path 172 and the second flow path 174 may vary due to the deviation of the lubricant LB. For example, during a right turn, as shown in FIG. 6B, the lubricant LB around the ring gear 28 increases, the oil level increases, and the amount of scraping by the ring gear 28 increases. Even in such cases, the lubricant LB merges and aggregates in the connecting portion 176 and the third flow path 178, and is discharged from the discharge port 178a. As a result, the discharge rate from the discharge port 178a is stably secured.

As described above, the drive devices 10 and 110 include the merging portions 60 and 160 that are common to the left and right drive units 12 and 14. Each of the merging portions 60 and 160 is configured to join and collectively discharge the left and right scraped-up lubricant LB. Therefore, even if the left and right deviations occur in the oil surface of the lubricant LB in which the left and right ring gears 28 and 48 are immersed, variations in the discharge amounts of the lubricant LB to the left and right drive units 12 and 14 corresponding to such deviations are suppressed. Then, the lubricant LB is stably discharged from the discharge port 80a, 82a, 178a to the left and right drive units 12 and 14, and is supplied. As a result, the left and right drive units 12 and 14 are stably lubricated and cooled.

The above-described embodiment is an embodiment of the technology disclosed in the present specification, and is not intended to limit the embodiment of the technology.

In the first embodiment, the two discharge ports 80a, 82a are configured to discharge the lubricant LB to the drive units 12 and 14, respectively, but the present disclosure is not limited thereto. Similarly, in the second embodiment, one discharge port 178a is provided, but the present disclosure is not limited thereto. The discharge ports may be single or may be provided in two or more or three or more. Further, the discharge destination of the lubricant LB intended by the discharge port 80a, 82a, 178a is not limited. The outlet may be provided to direct any element or portion of the drive units 12, 14.

In the first and second embodiments, the housing 16 includes the partition wall portion 18 that separates the lower portions of the left and right drive units 12 and 14, but the present disclosure is not limited thereto and may be a housing that does not include the partition wall portion 18. Even in this case, even if the rotational gravitational force is generated and uneven distribution of the lubricant LB occurs in the housing 16 in the left-right direction, the drive devices 10 and 110 can stably supply the lubricant LB to the left and right drive units 12 and 14.

In the first and second embodiments, the storage portion 62 and the storage portion 162 are not particularly provided with other discharge ports of the lubricant LB, but may be provided with other discharge ports as needed. In the other discharge ports, the lubricant LB is stably discharged through the merging portions 60 and 160.

The motors 102 and 104 and the gear sets 112 and 114 in the first and second embodiments are not limited to the above-described aspects, and a person skilled in the art can appropriately set different arrangements and configurations.

In the first and second embodiments, the lubricant LB is scraped toward the lubricant merging portions 60 and 160 by rotating the ring gears 28 and 48, but the present disclosure is not limited thereto. For example, the rotation shaft X2 may be arranged downward so that at least a portion of the lower side of the first counter gears 24 and 44 is immersed, and the first counter gears 24 and 44 may scrape up the lubricant LB to join the lubricant merging portions 60 and 160.

In the second embodiment, the storage portion 162 is provided, but the present disclosure is not limited thereto. Even if the flow path member 170 is provided and the storage portion 162 is not provided, the lubricant LB is discharged after merging and aggregating in the flow path member 170. Even when the storage portion 162 is not provided, the discharge hole portions 172b, 174b of the lubricant LB may be provided at any position. The lubricant LB discharged from the discharge hole portions 172b, 174b can lubricate and cool the elements of the drive units 12, 14 in the housing 16.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. A drive device comprising:
a first drive unit that includes a first motor and a first gear that drive a left wheel of a vehicle;
a second drive unit that includes a second motor and a second gear that drive a right wheel of the vehicle;
a housing that accommodates the first drive unit and the second drive unit and that is able to store a lubricant to an extent that a portion of the first gear and the second gear is immersed; and
a lubricant merging portion that merges the lubricant splashed up by the first gear and the lubricant splashed up by the second gear.

2. The drive device according to claim 1, wherein the lubricant merging portion includes a storage portion that is able to store the lubricant, a first intake port for taking the lubricant splashed up by the first gear into the storage portion, a second intake port for taking the lubricant splashed up by the second gear into the storage portion, and one or more discharge ports that discharge the lubricant from the storage portion toward the first drive unit and the second drive unit.

3. The drive device according to claim 2, wherein the one or more discharge ports include a first discharge port that discharges the lubricant toward the first motor and a second discharge port that discharges the lubricant toward the second motor.

4. The drive device according to claim 1, wherein:
the lubricant merging portion includes a flow path member includes a first flow path, a second flow path, a coupling portion between the first flow path and the second flow path, and a third flow path;
the first flow path has a first intake port for taking in the lubricant splashed up by the first gear;
the second flow path has a second intake port for taking in the lubricant splashed up by the second gear; and
the third flow path has one or more discharge ports that extend from the coupling portion and that discharge the lubricant toward the first drive unit and the second drive unit.

5. The drive device according to claim 4, wherein the lubricant merging portion further includes a storage portion that communicates with the first flow path and the second flow path and that is able to store the lubricant.

6. The drive device according to claim 4, wherein the one or more discharge ports include one discharge port that discharges the lubricant toward the first drive unit and the second drive unit.
